(19) United States
(12) Patent Application Publication
(10) Pub. No.: US 2015/0334417 A1
(43) Pub. Date: Nov. 19, 2015

(54) Coding a Sequence of Digital Images

(71) Applicant: FRIEDRICH-ALEXANDER-UNIVERSITÄT ERLANGEN-NÜRNBERG, Erlangen (DE)

(72) Inventors: Peter Amon, München (DE); Andreas Hutter, München (DE); André Kaup, Effeltrich (DE); Eugen Wige, Dresden (DE)

(21) Appl. No.: 14/653,237

(22) PCT Filed: Dec. 18, 2012
(86) PCT No.: PCT/EP2012/075988

§ 371 Date: Jun. 17, 2015

(51) Int. Cl. H04N 19/593; H04N 19/105; H04N 19/137; H04N 19/182

(52) U.S. Cl. CPC H04N 19/593; H04N 19/182; H04N 19/105; H04N 19/137

(57) ABSTRACT

A method is provided for coding a sequence of digital images, wherein the method uses a number of prediction modes for predicting values of pixels in the images based on reconstructed values of pixels in image areas processed previously, where a prediction error between predicted values and the original values of pixels is processed for generating the coded sequence of digital images.

### CROSS-REFERENCE TO RELATED APPLICATIONS

The present patent document is a §371 nationalization of PCT Application Serial Number PCT/EP2012/075988, filed Dec. 18, 2012, designating the United States, which is hereby incorporated by reference.

### TECHNICAL FIELD

The embodiments refer to a method for coding a sequence of digital images as well as to a corresponding decoding method. Furthermore, the embodiments refer to an apparatus for coding a sequence of digital images and an apparatus for decoding a sequence of digital images.

### BACKGROUND

In many different applications, e.g. in surveillance systems or in medical imagery apparatus, a great amount of image and video data is produced. Hence, there is a need to compress this data in order to save storage capacity or to reduce the bandwidth when transmitting the data.

In the prior art, there exist various standards in order to compress image and video data. Prominent examples of the standards are H.264/AVC (AVC=Advanced Video Coding), (see Wiegand et al., “Overview of the H.264/AVC Video Coding Standard,” IEEE TRANSACTIONS ON CIRCUITS AND SYSTEMS FOR VIDEO TECHNOLOGY, Vol. 13, No. 7, JULY 2003) as well as the draft standard HEVC (HEVC=High Efficiency Video Coding), (see also Sullivan et al., “Overview of the High Efficiency Video Coding (HEVC) Standard,” Pre-Publication Draft to Appear in IEEE TRANS. ON CIRCUITS AND SYSTEMS FOR VIDEO TECHNOLOGY, December 2012), which may be standardized also as ITU-T Recommendation H.265. The standard HEVC will also allow the real-time transmission of lossless coded image sequences. The standards HEVC and H.264/AVC include different intra-prediction modes based on blocks in the same image. In those modes, a current block is predicted for already reconstructed pixels in the neighborhood. An encoder may test different prediction types and choses the one with minimal cost with respect to certain distortion criterion. The prediction error is built for the current block and is transmitted to the decoder together with the prediction type. Block-wise prediction has the disadvantage that pixels that are far away from the reference pixels used for prediction do not correlate well with the reference pixels. Hence, the prediction error may be higher for those pixels. In order to improve the prediction, the size of a block may be reduced. However, this results in a higher number of blocks in an image, which leads to a higher bitrate for signaling of the prediction type. Furthermore, if the reference pixels contain noise, those pixels become suboptimal for prediction.

In Tan et al., “Intra Prediction by Template Matching,” IEEE International Conference on Image Processing (ICIP 2006), Atlanta, Ga., USA, October 2006, an intra-prediction mode based on template matching is described. In this method, a candidate block used for prediction of a current block is determined in a search region on the basis of templates of neighboring pixels adjacent to the candidate block and the block to be predicted. The candidate block with the best matched template in comparison to the template of the block to be predicted will be used for prediction. The prediction scheme has the disadvantage that the predicted block is still noisy, which is suboptimal for compression of noisy images.

A simple and efficient pixel-wise prediction method is proposed in Weinberger et al., “The LOCO-I lossless image compression algorithm: Principles and standardization into JPEG-LS,” IEEE Transactions on Image Processing, August 2000. This prediction method named LOCO-I uses an algorithm to predict a pixel based on three surrounding pixels. This prediction method is not optimal for compression for noisy images, either.

In Li et al., “Edge-Directed Prediction for Lossless Compression of Natural Images,” IEEE Transaction on Image Processing, June 2001, least-squares based methods for prediction are presented. In those methods, a weighted average of reconstructed pixels in the neighborhood to be predicted is performed. In order to get optimal weights for the averaging process, a complex system of equations has to be solved resulting in an enormous computational overhead. Hence, such prediction methods are not used in practical applications.

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object to provide a coding of sequence of digital images overcoming the above disadvantages and enabling an efficient compression with low complexity. Furthermore, it is an object to provide a corresponding decoding method as well as an apparatus for coding and an apparatus for decoding.

The method for coding a sequence of digital images uses a number of prediction modes (e.g., at least one prediction mode) for predicting values of pixels in the images based on reconstructed values of pixels in image areas processed previously. The term “reconstructed values of pixels” is to be interpreted broadly and depends on the used coding scheme. For lossless coding, the reconstructed values of pixels correspond to the original value of pixels. In case of a lossy coding, the reconstructed values of pixels correspond to coded and thereafter decoded values of pixels. Moreover, the reconstructed values of pixels may also refer to predicted values of pixels determined in the corresponding prediction mode. Predicted values of pixels are used in case that a coding and decoding of the respective pixel has not yet been performed when predicting the current pixel.

In a coding method, a prediction error between predicted values and the original values of pixels is processed for generating the coded sequence of digital images.

The method is characterized by a special preset prediction mode, which is an intra-prediction mode based on pixels of a single image. This preset prediction mode includes acts i) and ii) as explained in the following.

In act i), for a region of pixels with reconstructed values in a single image and for a template of an image area, a first patch of pixels in the region that surrounds a first pixel to be predicted based on the template is compared with several second patches, each second patch being assigned to a second pixel in the region and including pixels in the region that surround the second pixel based on the template. Based on this comparison, a similarity measure for each second pixel is determined that describes the similarity between reconstructed values of the pixels of the second patch assigned to the respective second pixel and the reconstructed values of the pixels of the first patch.

In act ii) of the method, a predicted value of each first pixel is determined based on a weighted sum of (e.g., reconstructed) values of the second pixels, where the value of each second pixel is weighted by a weighting factor, which is monotonously decreasing in dependency on a decreasing similarity described by the similarity measure for the respective second pixel. Here and in the following, the term “monotonously decreasing” denotes that the weighting factor will decrease at least for larger decreases of the similarity. In other words, for smaller decreases in the similarity it may happen that the weighting factor remains constant.

The coding method is based on the idea that a non-local means algorithm, which is known for denoising pixels (see Buades et al., “A non-local algorithm for image denoising,” IEEE Computer Society Conference on Computer Vision and Pattern Recognition (CVPR 2005), Washington, D.C., USA, June 2005), may be configured in order to be used for prediction. To do so, the templates used for prediction are restricted to a (e.g., causal) region only including reconstructed values of pixels in the image. The method provides an efficient coding without the need of solving a linear system of equations as it is the case in prior art methods. Furthermore, there is no restriction in the number of second pixels to be used for predicting a first pixel. Moreover, there is no need of transmitting side information from the encoder to the decoder because the prediction scheme is backward adaptive. Furthermore, the prediction is carried out sample-based so that the prediction error does not depend on the pixel position.

In one embodiment, the weighting factors are the similarity measures or approximated values of the similarity measures so that no separate calculation of the weighting factors has to be performed. However, the weighting factors may also be the similarity measures normalised over all similarity measures determined in act i) or approximated values of the similarity measures normalised over all similarity measures determined in act i).

In another embodiment, the preset prediction mode is performed block-wise for first pixels in predetermined image blocks. Hence, the method may be easily combined with block-based coding schemes.

In an embodiment, the similarity measure is based on the sum of absolute or squared differences between corresponding (e.g., reconstructed) pixels in the first patch and the respective second patch. The sum of absolute or squared differences may be included in the similarity measure as at least a part of a negative exponent of a basis. For a calculation of the similarity measure, the basis may have the value 2. Other values for the basis may be used as well.

In an embodiment, the similarity measure in act i) and/or the predicted value of each first pixel in act ii) are determined based on an integer arithmetic. This enables a coding with low computational efforts. In the detailed description, an example is described how integer arithmetic may be implemented in the coding method.

In another embodiment, a look-up in a predefined table is used for determining the similarity measures in act i). By using such a predefined table, the computing time for coding may be further reduced. The table may provide values of the similarity measure for values of the sum of absolute or squared differences between corresponding pixels in the first patch and the respective second patch.

In an embodiment, the preset prediction mode is used for lossless coding of the sequence of images. In this case, reconstructed values of pixels used in act i) are equal to the original values of pixels.

In another embodiment, the preset prediction mode is used for lossy coding of the sequence of images. The lossy coding may include the known acts of a transform and/or the quantization of the (e.g., transformed) prediction errors, where an inverse transform and/or a dequantization of the prediction errors are performed for determining reconstructed values of pixels. In case that a prediction error for a pixel has not yet been subjected to the transform and/or quantization, the predicted value of the pixel is used as the reconstructed value.

In an embodiment, the processing of the prediction error includes an entropy coding act enhancing the coding efficiency.

In another embodiment, it is determined for each first pixel to be predicted based on arbitrary criteria whether the preset prediction mode or another prediction mode is to be used for the first pixel and/or which parameter or parameters of the first prediction mode are used.

In another variant, another prediction mode than the preset prediction mode is used for the first pixel in case that all similarity measures determined in act i) are zero.

In the method, one or more of the parameters of the preset prediction mode may be fixed and/or variable. The one or more parameters may include the form and the size of the template and/or the form and the size of the region and/or one or more parameters referring to the determination of the similarity measures and/or a determination of predicted values of first pixels. For example, the parameters may refer to the value of the above described basis exponent used for calculating the similarity measure.

In another embodiment, the preset prediction mode and/or parameters of the preset prediction mode are signaled in the coding sequence of images. In the detailed description, different variants for signaling the prediction mode or corresponding parameters are described.

In one variant, the preset prediction mode is used as a prediction mode in the standard HEVC/H.265, for which a draft version exists at the moment.

Besides the above method, a method for decoding a sequence of digital images is provided, which is decoded by one or more embodiments of the method. In the decoding method, the prediction error is reconstructed from the coded sequence of images and the values of the pixels in the coded sequence of images that are processed by the preset prediction mode during coding and are subjected to a special decoding process that includes acts i) to iii) as described in the following.

In act i), for a region of pixels with decoded values in a single image that have been determined previously in the decoding processing and for a template of an image area, a first patch of pixels in the region that surrounds a first pixel to be predicted based on the template is compared with several second patches, each second patch being assigned to a second pixel in the region and including pixels in the region that surrounds the second pixel based on the template, thereby determining a similarity measure for each second pixel describing the similarity between decoded values of the pixels of the second patch assigned to the respective second pixel and the decoded values of the pixels of the first patch.

In act ii), a predicted value of each first pixel is determined based on a weighted sum of (e.g., decoded) values of the second pixels, where the value of each second pixel is weighted by a weighting factor that is monotonously decreasing in dependency on a decreasing similarity described by the similarity measure for the respective second pixel.

In act iii), the predicted value of each first pixel is corrected by the corresponding reconstructed prediction error for the first pixel resulting in a decoded value of the first pixel.

A method is also provided for coding and decoding a sequence of digital images, wherein the sequence of digital images is coded by the coding method and wherein the coded sequence of digital images is decoded by the decoding method.

An apparatus is also provided for coding a sequence of images wherein the apparatus includes a device for performing an number of prediction modes for predicting values of pixels in the images based on reconstructed values of pixels in image areas processed previously, where the prediction error between predicted values and the original values of pixels is processed for generating the coded sequence of digital images.

In this apparatus, the device for performing a number of prediction modes includes a device for performing a preset prediction mode that is an intra-prediction mode based on pixels of a single image, where the device for performing the preset prediction mode includes: (1) a first device for determining similarity measures that is configured to perform an act in which, for a region of pixels with reconstructed values in the single image and for a template of an image area, a first patch of pixels in the region that surrounds a first pixel to be predicted based on the template is compared with several second patches, each second patch being assigned to a second pixel in the region and including pixels in the region that surrounds the second pixel based on the template, thereby determining a similarity measure for each second pixel describing the similarity between reconstructed values of the pixels of the second patch assigned to the respective second pixel and the reconstructed values of the pixels of the first patch; and (2) a second device for predicting values of first pixels that is configured to perform an act in which a predicted value of each first pixel is determined based on a weighted sum of values of the second pixels, where the value of each second pixel is weighted by a weighting factor that is monotonously decreasing in dependency on a decreasing similarity described by the similarity measure for the respective second pixel.

The above coding apparatus may include one or more additional devices for performing one or more embodiments of the coding method.

An apparatus is provided for decoding a sequence of digital images that is coded by the method. The apparatus includes a decoding device to reconstruct the prediction error from the coded sequence of images and to decode the values of the pixels in the coded sequence of images that are processed by the preset prediction mode during coding.

The decoding device of the apparatus includes: (1) a first device for determining similarity measures that is configured to perform an act in which for a region of pixels with decoded values in the single image that have been determined previously in the decoding processing and for a template of an image area, a first patch of pixels in the region that surround a first pixel to be predicted based on the template is compared with several second patches, each second patch being assigned to a second pixel in the region and including pixels in the region that surrounds the second pixel based on the template, thereby determining a similarity measure for each second pixel describing the similarity between decoded values of the pixels of the second patch assigned to the respective second pixel and the decoded values of the pixels of the first patch; (2) a second device for predicting values of first pixels that is configured to perform an act in which a predicted value of each first pixel is determined based on a weighted sum of values of the second pixels, where the value of each second pixel is weighted by a weighting factor that is monotonously decreasing in dependency on a decreasing similarity described by the similarity measure for the respective second pixel; and (3) a third device for correcting the predicted values of first pixels that is configured to perform an act in which the predicted value of each first pixel is corrected by the corresponding reconstructed prediction error for the first pixel resulting in a decoded value of the first pixel.

A codec is provided for coding and decoding a sequence of digital images, including a coding apparatus and a decoding apparatus.

### BRIEF DESCRIPTION OF THE DRAWINGS

FIG. 1 depicts a known method for image denoising based on a non-local means algorithm.

FIG. 2 depicts examples of different templates that may be used in the prediction method.

FIG. 3 depicts the prediction of a pixel based on an embodiment.

FIG. 4 is a flowchart depicting an enhanced prediction based on an embodiment.

FIG. 5 is a schematic illustration of an example of a coding method implementing the prediction mode.

FIG. 6 is a schematic illustration of an example of a decoding method implementing the prediction mode.

FIG. 7 illustrates an example of the use of the prediction mode in a block-based lossless coding.

FIG. 8 illustrates an example of the prediction method in a block-based lossless coding.

FIG. 9 is a schematic illustration of a coding and decoding apparatus according to an embodiment.

### DETAILED DESCRIPTION

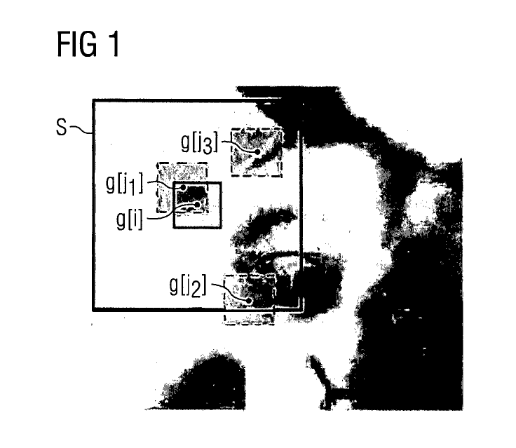

Before describing the embodiments in detail, a prior art method used for image denoising is explained. FIG. 1 depicts an image that shall be denoised based on a so-called non-local means algorithm (also abbreviated as NLM) that is described in Buades et al., “A non-local algorithm for image denoising,” IEEE Computer Society Conference on Computer Vision and Pattern Recognition (CVPR 2005), Washington, D.C., USA, June 2005. In this NLM denoising method, an estimate for a denoised version of a noising pixel is established by averaging all the pixels in the local as well as the non-local neighborhood of the corresponding image. This averaging is based on a weighted sum taken into account the similarities between a number of local neighboring pixels of noisy pixels and a number of non-local neighboring pixels of other pixels in a predetermined area around the noisy pixel. In this way, the NLM algorithm exploits the fact that similar image content is present in different areas of an image and may therefore be considered during an average process. According to FIG. 1, the pixel i having the pixel value g[i] shall be denoised. To do so, a weighted average of all pixels in the area S surrounding pixel i is calculated. The weights for calculating the average are calculated based on a first patch around the noisy pixel and a second patch around the pixel for which the weight is to be calculated. The patches are based on a predetermined template that is a square in FIG. 1 indicated by a dashed border. FIG. 1 depicts as example pixels j₁, j₂ and j₃ with corresponding pixel values g[j₁], g[j₂], and g[j₃], respectively. For the calculation of the weights of those pixels, the corresponding patches based on the template around the pixels are compared with the patch around the noisy pixel i, which is indicated by a solid line. For calculating the similarity, the pixels in the patch around pixel i are compared with the corresponding pixels of patches around other pixels in the area S. In the example depicted in FIG. 1, the pixel j₃ will get a higher weight than the pixels j₁ and j₂. This is because the patch of pixel i and of pixel j₃ lie along the same border in the image and are, thus, more similar to each other than the patch of pixel i to the patch of pixel j₁ or the patch of pixel i to the patch of pixel j₂.

A formal description of the above-described NLM algorithm is given in the following. The averaging process is based on the following formula:

$${p}_{NLM} [ i ] = {\sum }_{j ∈ S} w [ i , j ] g [ j ] , \qquad ( 1 )$$

where g[i] is the noisy value of pixel i, p_{NLM}[i] is the NLM-processed image (e.g., the denoised value of the pixel i) and S is the region for denoising (e.g., a square area of (2Dₘₐₓ+1)*(2Dₘₐₓ+1) samples, where Dₘₐₓ is the maximum spatial distance). Furthermore, w[i,j] are the weights for the samples/pixels in the area S. The weights w[i,j] are defined as:

$$w [ i , j ] = \frac{{e}^{- \frac{‖ {P}_{g}^{k} [ i ] - {P}_{g}^{k} [ j ] ‖}{{h}^{2}}}}{{\sum }_{j} {e}^{- \frac{‖ {P}_{g}^{k} [ i ] - {P}_{g}^{k} [ j ] ‖}{{h}^{2}}}} , \qquad ( 2 )$$

where P_{g}^{k}[i] determines a square patch of |P_{g}^{k}[i]=(2k+1)*(2k+1) pixels with the center pixel i. For calculation of the Euclidian norm ∥•∥, the whole square neighborhood is used:

$$‖ {P}_{g}^{k} [ i ] - {P}_{g}^{k} [ j ] ‖ = \frac{1}{{( 2 k + 1 )}^{2}} {\sum }_{n ∈ {N}_{0}} {( g [ i - n ] - g [ j - n ] )}^{2} , \qquad ( 3 )$$

where N₀={(x,y)|−k≦x≦k,−k≦y≦k}, where (x,y) refers to a 2-dimensional position of a pixel in the image.

From the above equations, the pixels with a similar neighborhood get higher weights whereas pixels with different neighborhoods get lower weights for the non-local averaging.

Contrary to the embodiments as described in the following, the above algorithm does not follow causal relations in the sense that a predetermined coding sequence is taken into account. For example, the above denoising method does not consider the fact that a coding method may only process pixels that have already been at least partially coded and reconstructed before because otherwise a proper decoding is not possible.

The prediction method described in the following configures the above NLM algorithm by considering causal relations. The prediction method is based on intra-prediction and uses for a pixel to be predicted patches around pixels in a predetermined region of already reconstructed pixels. The prediction method is implemented as a prediction mode in a coding method and may be particularly used in the video coding (draft) standard HEVC/H.265.

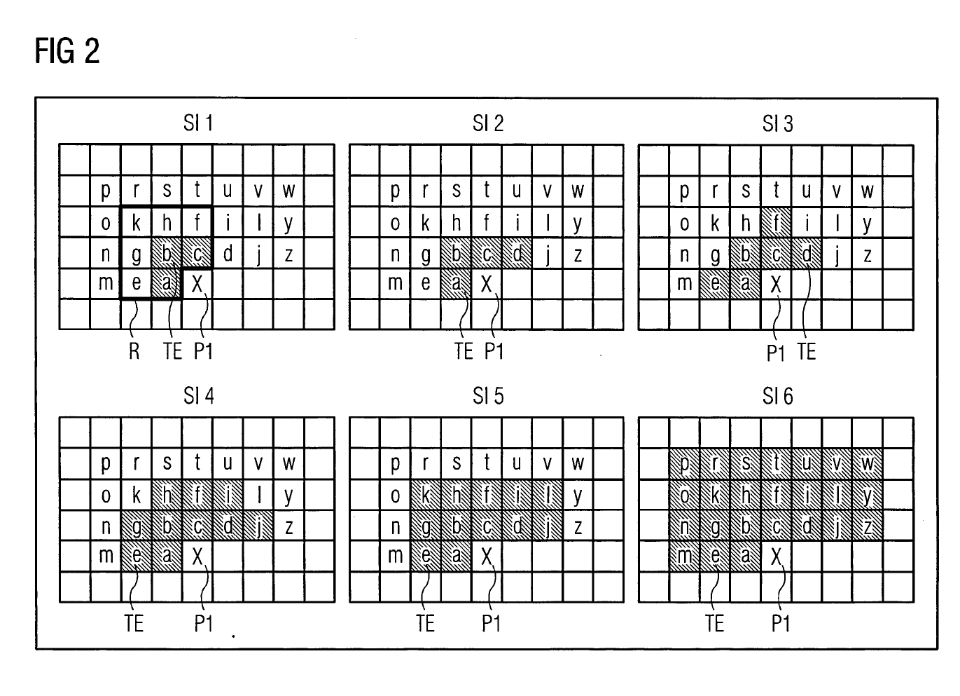

FIG. 2 illustrates different forms and sizes SI1, SI2, . . . , SI6 of templates for patches that may be used in an embodiment. In this figure, a first pixel to be predicted in an image is designated as P1 and has the pixel value X. In this figure, the coding order is line by line where all pixels in lines above the pixel P1 and all pixels in the line of pixel P1 at the left side of this pixel have already been coded. In order to calculate a similarity measure, patches based on templates according to sizes SI1 to SI6 may be used. The corresponding templates TE are indicated as dashed pixels for each form and size. For example, the template of form and size SI1 includes pixels a, b, c, the template of form and size SI2 includes pixels a, b, c, d, the template of form and size SE3 includes the pixels e, a, b, c, d, f and so on. In the following, the term weight corresponds to a similarity measure as defined in the claims. Furthermore, the weight normalized by the sum of weights in a region corresponds to a weighting factor as defined in the claims.

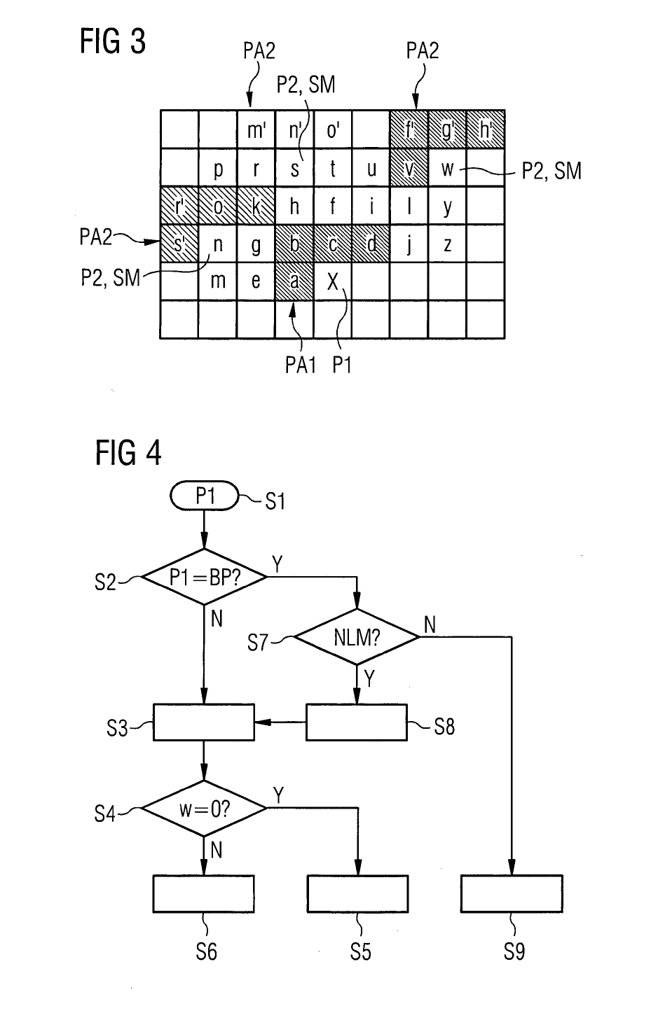

FIG. 2 also illustrates a region R, which defines a neighborhood region of those pixels that are taken into account when predicting the value for pixel P1. According to the region R, the pixels a, b, and c corresponding to second patches adjacent to those pixels based on the template TE are used for calculating a similarity measure SM (see FIG. 3). For example, the first patch including the pixels a, b, and c is compared with the second patch of pixels around pixel a (e.g., pixels e, g, and b), with the second patch of the pixels around pixel b (e.g., pixels g, k, and h) and with the second patch around the pixel c (e.g., pixels b, h, and f) in order to determine similarity measures/weights between the first and the respective second patch. Hence, the neighborhood region is based on the patches around the pixels defining a template. This is also the case for the other template sizes SI2 to SI6. Hence, the definition of the template sizes also corresponds to a definition of a neighborhood region size.

The above-described calculation of similarity measures for predicting a first pixel P1 is further illustrated in FIG. 3. FIG. 3 uses for the prediction of the pixel P1 patches based on the template of the size SI2 in FIG. 2. Those templates have an L-form and include four pixels. To determine the predicted value of pixel P1, the first patch including pixels a, b, c, and d around P1 is compared to second patches around the pixels n, s, and w in FIG. 1. Those pixels are second pixels P2. The corresponding weight or similarity measure SM for each of those pixels is calculated by comparing the pixel values of the first patch PA1 with the corresponding pixels values of the second patch surrounding the corresponding pixel P2. For example, for pixel P2 having the value s, the difference between the pixel value a of PA2 and a of PA1, the difference of pixel value m′ of PA2 and pixel value g of PA1, the difference of pixel value n′ of PA2 and pixel value c of PA1 and the difference of pixel value o′ of PA2 and pixel value d of PA1 are summed for calculating the weight of pixel P2 having the value s. In the embodiment of FIG. 3, all pixels in the region corresponding to the pixels indicated by dashed lines in size SI6 of FIG. 2 are used as second pixels for which a weight is calculated.

As there is no knowledge about the pixel P1 to be predicted, only asymmetrical patches are used for calculating weights contrary to the method of FIG. 1. As the prediction method has to be used in both the encoder and decoder, the choice of the patch sizes and the regions of second patches has to be done carefully with respect to the prediction computational complexity since increasing the number of second patches or the patch size may dramatically increase the runtime for prediction. For accurate prediction, an increase in the patch sizes may also require a dramatic increase in the number of second patches used for averaging. This is because, if the patch becomes larger, the structural complexity of the patch becomes higher, so it becomes harder to find similar patches. The computations as described with respect to the NLM algorithm of FIG. 1 is configured for a prediction method by using a different size of patches/templates and considering only causal pixels for calculating a pixel value. Furthermore, in order to speed up the computations, some simplifications are used in an embodiment. The problem of using the original equations of the NLM algorithm depicted in FIG. 1 is that the implementation requires a float or double arithmetic. This is because the original NLM algorithm for denoising requires weights that are in the range between 0 and 1. In order to simplify these computations, the following equation for calculating the predicted pixel value p_{NLM}[i] is used:

$${p}_{NML} [ i ] = \frac{{\sum }_{j ∈ S} w [ i , j ] g [ j ]}{{\sum }_{j ∈ S} w [ i , j ]} . \qquad ( 4 )$$

The weights/similarity measures w[i,j] are considered to be integer values. A second modification has to be done for the calculation of the weights in order to support an integer version of the calculation. This modification is described by the following calculation of the weights w[i,j]:

$$w [ i , j ] = a \cdot {b}^{- \frac{d ( {P}_{g}^{k} [ i ] - {P}_{g}^{k} [ j ] )}{{h}_{d}}} . \qquad ( 5 )$$

The term d(P_{g}^{k}[i]−P_{g}^{k}[j]) is defined in an embodiment as ∥P_{g}^{k}[i]−P_{g}^{k}[j]∥ according to equation (3) but with different patch size. Furthermore, different basis values b for the exponential function may be used. Also, different distance measure functions d(.,.) may be allowed. The factor a in the above equation is a scaling factor because the result of the exponential function may become very small rapidly that would introduce coarse quantization into the weights if integer arithmetic implementation is used. The above adjusting parameter h_{d} depends on the used distance measure. In an embodiment, the weights w[i,j] are calculated using floating-point arithmetic but rounded to integer values.

The computation of this measure of the original NLM algorithm for denoising may be simplified by skipping the normalizing of the distance. For example, the sum of squared errors SSE as described by:

$${d}_{SSE} = {\sum }_{n ∈ {N}_{0}} {( g [ i - n ] - g [ j - n ] )}^{2} \qquad ( 6 )$$

may be replaced by the measure of the sum of absolute distance SAD described by:

$${d}_{SAD} = {\sum }_{n ∈ {N}_{0}} \vert g [ i - n ] - g [ j - n ] \vert . \qquad ( 7 )$$

In an embodiment, the value of the parameter a may be chosen to be high in order to get different integer values. Furthermore, the basis b may be chosen to be low, e.g. 2 or “e”.

The above sizes SI1 to SI6 also give so-called neighborhood sizes that refer to those pixels for which a patch of surrounding pixels is compared with a patch of pixels surrounding pixels P1. The pixels processed according to the neighborhood size SE1 are included in the region R.

In another embodiment, the weights calculated according to above equation (7) are discarded in case that those weights are lower than a predetermined threshold. This reduces the number of operations to calculate the predictor.

In the following, further enhancements of the above description method are described. FIG. 4 depicts a flowchart for an enhanced prediction of pixels where irregular cases are taken into account during processing. The prediction starts at act 51 with a pixel P1. In act S2, it is determined whether pixel P1 is a bounding pixel BP at the border of the image. If not (branch N), the weights w[i,j] are calculated in act S3 as described above. In act S4, it is determined whether all weights are 0. If this is the case (branch Y), an exception algorithm for predicting the pixel value is used in act S5. If not all pixels are 0 (branch N), the regular NLM algorithm is used in act S6. In case that the pixel P1 is a boundary pixel (branch Y out of act S2), it is determined whether the NLM algorithm shall be used at all. Any criteria may be used for this determination. For example, it may be indicated beforehand whether NLM shall be used or not by a corresponding flag set in the encoder. In case that the NLM algorithm shall be used (branch Y), new NLM parameters for boundary pixels are determined in act S8. Thereafter, the method continuous with acts S3, S4, S5, and S6. In case that NLM shall not be used according to act S7 (branch N), an appropriate exception algorithm for the boundary pixel is used in act S9.

Summarized, in case that the pixel to be predicted in FIG. 4 is a boundary pixel where not all of the needed reference pixels are available, another algorithm is chosen for prediction of this pixel or some parameters of the NLM prediction are changed to meet the requirements for availability of the needed reference pixels. If the NLM algorithm is determined to be used, the weights for NLM averaging are estimated as described above. If at least one weight is not 0, the regular NLM averaging process is performed for prediction of the current pixel. Otherwise, an exception algorithm is used for prediction. In this case and in the case of boundary pixels, different variants of the exception prediction algorithm may be implemented. For example, the mean value of surrounding pixels may be used for prediction; the well-known LOCO-I predictor (see Weinberger et al., “The LOCO-I lossless image compression algorithm: Principles and standardization into JPEG-LS,” IEEE Transactions on Image Processing, August 2000) is used as a prediction of the current pixel, or the parameters of the NLM predictor may be changed in order to perform a new test for prediction calculation.

In the following, an embodiment of an NLM prediction method is described. This embodiment is based on the patch size and neighborhood size SI1 depicted in FIG. 2. For the distance calculation within the predictor, the sum of absolute differences SAD (see equation (7)) is used. Instead of using an exp-basis, the basis b=2 is used for calculating the weights, and the division by h_{d} (see equation (5)) is realized by a right shift of 3 bits. For example, the weights are calculated using the following formula:

w[i_{—}X,j_{—}α]=2̂(−(dSAD(i_{—}X,j_α)>>3)) (8)

where i_X is the position of the pixel X to be predicted and where j_α is the position of the pixel α with α={a, b, c} are the pixels that are used for averaging. dSAD is calculated based on the corresponding pixels of the patches surrounding the pixel a by using the above equation (7). The symbol “>>3” represents the above-mentioned shift of 3 bits.

For calculating a predicted value of pixel X, an integer arithmetic based on the following equations is used:

X=(a·w[i_{—}X,j_{—}a]+b·w[i_{—}X,j_{—}b]+c·w[i_{—}X,j_{—}c]+(w[i_{—}X,j_{—}a]+w[i_{—}X,j_{—}b]+w[i_{—}X,j_{—}c])/2)/(w[i_{—}X,j_{—}a]+w[i_{—}X,j_{—}b]+w[i_{—}X,j_{—}c]) (9),

w[i_{—}X,j_{—}a]=TableSAD[dSAD(i_{—}X,j_α)] (10),

TableSAD[dSAD(i_{—}X,j_α)]=100000·2̂(−(dSAD(i_{—}X,j_α)>>3)) (11).

The term (w[i_X, j_a]+w[i_X, j_b]+w[i_X, j_c])/2 in equation (9) represents a rounding operation.

The above symbol “TableSAD” represents a one-dimensional table including predetermined calculations for different values of dSAD. For example, the differences dSAD are calculated in the method and thereafter, a lookup is done in the table in order to calculate the above value TableSAD. Hence, the above table operation may be described by the following formula:

dSAD=dSAD(i_{—}X,j_α) (12),

TableSAD[dSAD]=100000·2̂(−(dSAD>>3)) (13).

The above formulas explicitly express that the function dSAD is not calculated during the determination of the table but is used as a one-dimensional index for the table.

The scaling of the table by 100000 is necessary as the exponential term tends fast to small values, which are coarsely quantized if integer implementation is used. In cases where all table values give 0 for all weights, an escape for division by 0 is used. In this case, another predictor is used for the pixel X.

In the following, the implementation of the above described prediction method in a conventional coding and decoding method, which may be based on the draft standard HEVC/H.265, is described.

FIG. 5 depicts a block-based encoder receiving the sequence of images I to be decoded. The encoder includes at several positions a switch 1s that is in a position describing a lossless coding mount that uses the prediction method. In case that the switch NS is switched in a second position, a known coding is performed where a prediction error PE obtained by the differentiator is subjected to a transformation T and a quantization Q. This prediction error is then subjected to an entropy encoding EC so that a sequence of coded images CI is obtained. During this conventional coding, another prediction method than the method is used. To do so, the prediction error after quantization is dequantized and subjected to an inverse transform IT. This reconstructed prediction error is combined with a prediction value from the prediction module so that reconstructed pixel values of the corresponding block are obtained. These reconstructed values are stored in a buffer BF and used for performing prediction in the prediction module PR. The predicted value calculated in the module PR is then fed to the differentiator DI to provide a prediction error PE. Furthermore, a loop-filter LF is used for filtering the signal obtained by the adder AD.

In case that the lossless switch 1s is put in the position as depicted in FIG. 5, a lossless coding using the prediction method is performed. To do so, the blocks for transformation T, quantization Q, dequantization DQ, inverse transform IT, and loop-filter LF are bypassed. In this mode, the reconstructed prediction error PE fed to the adder AD corresponds to the original prediction error PE. Furthermore, the values of pixels in the causal region used for averaging are the original pixels because the original pixel values are available during decoding as the coding is lossless.

The loop-filter block LF may refer to different loop-filters, e.g., a deblocking filter, an SAO filter (SAO=Sample Adaptive Offset), and the like. When using the lossless coding, the prediction method based on the above-described NLM algorithm is used in the prediction module PR. The dotted lines L in FIG. 5 illustrate the inclusion of parameters of the prediction in the lossless and lossy coding mode in the sequence of coded images. Those parameters are also subjected to entropy coding. The state of the above lossless switch is may be signaled explicitly for each block, slice, frame, or sequence separately. However, the state may also be inferred for each block, slice, frame, or sequence from some other parameters, e.g. by using the quantization parameter QP. For example, in case that the quantization parameter has the value of 0, this may be the indication that the lossless mode is to be used.

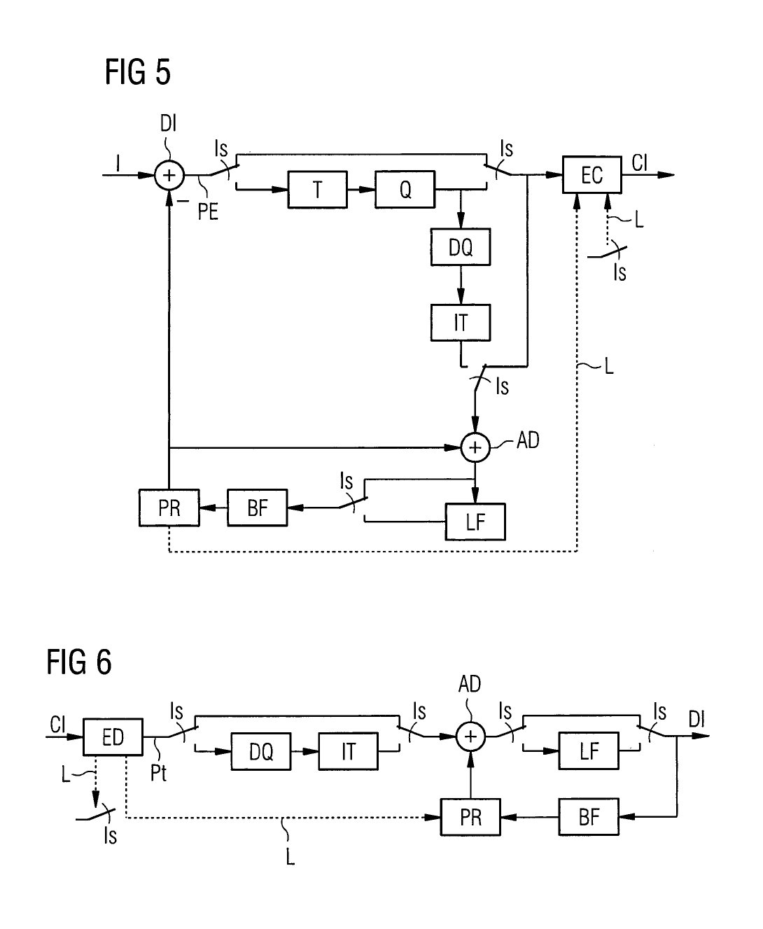

FIG. 6 depicts a decoder of the coded sequence of images CI obtained by the encoder of FIG. 5. At first, the images are subjected to an entropy decoding ED resulting in a prediction error PE. In case of a lossless encoding, the switches S are in the first positions as depicted in FIG. 6. As a consequence, the prediction error is used directly by the prediction module PR. To do so, the original pixel value is obtained by the adder AD and stored in the buffer BF. The stored values in the buffer BF are used for further prediction by the prediction module PR. Eventually, the sequence of decoded images DI being identical to the original images I is obtained. In case of a lossy encoding, more switches are put in the second position so that in a known manner a dequantization DQ, an inverse transform IT and loop-filters LF are applied to the signal in order to perform another prediction in the prediction module PR. As a consequence, a decoded sequence of images is obtained where some information is lost due to quantization and transformation. The dotted line L in FIG. 6 represents the provision of parameters originally included in the coded sequence of images that are needed by the predictor module PR to perform appropriate prediction. In the lossy coding mode, well-known prediction techniques based on INTRA as well as on INTER prediction may be used.

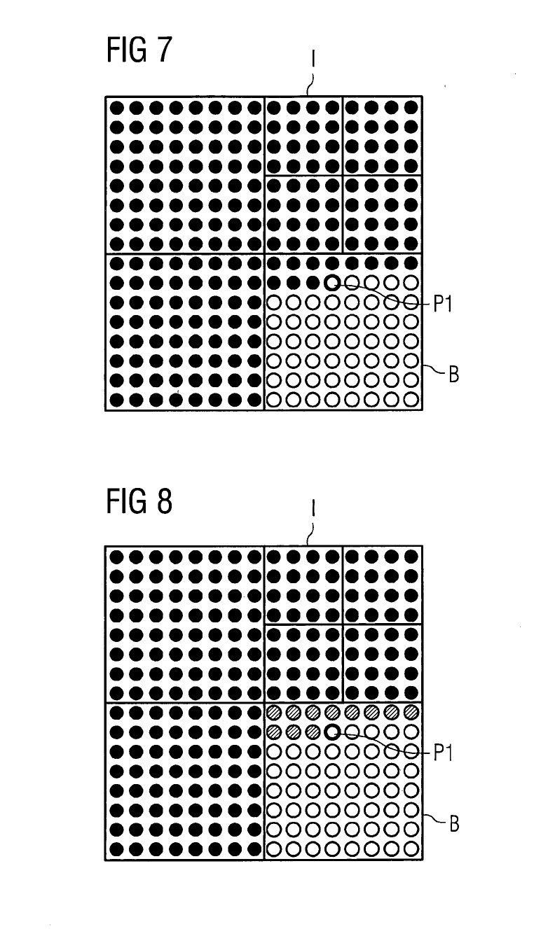

FIG. 7 illustrates the above-described pixel-wise NLM prediction in a block-based lossless coding scheme. In FIG. 7, the block B in the right lower edge of image I is currently predicted. This block refers to a so-called transform unit where all pixels in the block are subjected to a transform in case that the lossy coding mode is used. Instead of a transform unit, the block may also be a coding unit or a prediction unit. The blocks with white background colors and exclusively including black pixels are already reconstructed and are used for prediction of the current block B.

FIG. 7 depicts the scenario in which the pixel P1 is currently predicted in the block B. The black pixels in the block B have already been reconstructed and refer to the original pixels due to the lossless coding. The prediction in FIG. 8 is performed in a line-scan order but also other scan orders may also be used. The pixel-based NLM prediction begins with the top left pixel and the block B. This pixel is predicted using the described NLM prediction algorithm. The top left pixel of the prediction error is calculated by the difference between the original pixel and the predicted pixel. Afterwards, the original pixel is immediately written into the reconstructed buffer in order to be used for the prediction of the next pixel and so on. Hence, when the pixel P1 depicted in FIG. 7 is predicted, the predictor may only use the already available pixels represented by black circles for prediction. This procedure continues until all white pixels that have to be compressed are predicted in the block B.

As mentioned above, the prediction method is to be implemented in the draft standard HEVC/H.264. The prediction method may be used for lossless coding as described above. If a corresponding coding unit is coded in a lossless way, the transformation, quantization and loop-filtering within the encoder are disabled as depicted in FIG. 5. Similarly, the inverse transformation, the dequantization and the loop-filtering are disabled within the decoder, too. The following options may be used in order to incorporate the NLM prediction method into the HEVC syntax: (1) a certain prediction mode for NLM prediction is used in addition to the modes INTRA and INTER; (2) a certain prediction type for the NLM prediction mode in addition to the defined prediction types in INTRA prediction is used; (3) certain prediction modes or prediction types within the HEVC syntax are replaced by the prediction mode; (4) a combination of existing prediction modes and prediction types with the NLM prediction mode is used; (5) a certain value (e.g. 0) is used for the quantization parameter.

Different parameters of the NLM prediction method may be sent as side information: (1) the patch form and the patch size; (2) the neighborhood form and the neighborhood size; (3) the parameters a (scaling factor), b (exponential basis), d (distance measure) and the modeling parameter h_{d} (divisor in the exponent).

The above parameters may be sent frequently, e.g., for each picture, slice (e.g., partition of a picture) or coding unit in order to configure to the statistics of the image signal. The parameters may also be sent only once for an image sequence or jointly for several images, e.g., within a parameter set like the sequence parameter set or the picture parameter set. As an alternative, the parameters may also be estimated by a defined algorithm. As another alternative, these parameters may be fixed in a certain profile and/or level of the standard and, thus, need not be transmitted or estimated at all.

Furthermore, the entropy coding of the prediction error may be configured with respect to the statistical properties of the prediction error of the NLM prediction method. Therefore, a special binarization scheme as well as context modeling may improve the compression results.

The following adaptations with respect to the coding order using the NLM prediction mode may be optionally implemented: (1) the causal neighborhood for the NLM prediction mode may be linked to the coding unit order or prediction unit order. In this case, the prediction and reconstruction follows the original prediction and reconstruction order of the HEVC draft standard; (2) the casual neighborhood for the NLM prediction mode may be limited by the size for a coding unit and the coding/decoding order. In this case, different coding units may be encoded and decoded in parallel depending on the already reconstructed neighboring coding units or other partitions in the image; (3) the causal neighborhood for the NLM prediction mode may be limited by a size of a prediction unit and the coding/decoding order. In this case, different prediction units may be encoded and decoded in parallel depending on the already reconstructed neighboring prediction units or other encoding units.

The NLM prediction method may be used in block-wise coding methods as well as in pixel-based coding methods. Hence, the combination of different pixel-based prediction methods with the NLM prediction method may be used. Furthermore, the NLM prediction method may be used for both lossless coding and transform-based coding.

In one embodiment, the NLM prediction algorithm is used in combination with the above mentioned LOCO-I algorithm. Particularly, if the LOCO-I algorithm does not detect a vertical or horizontal edge, the NLM prediction algorithm is used for prediction of the current pixel.

Furthermore, the NLM prediction may also be used for lossy pixel-wise coding. To do so, the NLM prediction mode is constructed as described before using the NLM prediction algorithm. Afterwards, the prediction error for the corresponding pixel is built that is quantized in order to achieve redundancy reduction. This procedure is performed for each pixel individually.

Moreover, the NLM prediction method may also be used for lossy transform coding. To do so, the prediction error block has to be built before transform and quantization is performed. When performing prediction, the causal available reconstructed pixels are used for prediction of the neighboring pixels. The predicted pixels and the causally available pixels are used for prediction of further pixels until the prediction block is filled. The block is used for prediction error building that is transformed and quantized afterwards. FIG. 8 depicts an example of such a block-based lossy coding.

In this figure, circles represent pixels of a certain image area analogously to FIG. 7. The area is divided in several blocks that are coded separately. The blocks with the white background color are already reconstructed and are used for prediction of the current block B forming a transform unit. In this block, the pixel P1 is currently predicted. The hatched pixels in FIG. 8 represent predicted values of pixels. According to FIG. 8, the prediction is performed in a line-scan order but other scan orders may also be used. The pixel-based NLM prediction begins with the top left pixel of block B. This pixel is predicted using the above-described NLM prediction algorithm. For prediction of the top left pixel, all black circles from other blocks may be used if they are already reconstructed. The pixel is predicted and the predicted value indicated by the corresponding hedged circle is further used as a reference sample for the prediction of other pixels, and so on. For the prediction of the pixel P1 in FIG. 8, the already reconstructed pixels from other blocks (black circles) and the already predicted pixels from the current block (orange circles) may be used. The process continuous until all pixels within the block B are predicted. Thus, a prediction block is generated, which is subtracted from the current block in order to get a prediction error block. The prediction error block may then be transformed, quantized, dequantized, and inverse transformed as it is common in a lossy transform encoder. At the decoder, the quantized transform coefficients are dequantized, inverse transformed, and added to the NLM predicted block in order to get the lossy reconstructed block.

The embodiments as described in the foregoing have several advantages. Particularly, an automatic backward adaptive prediction method is provided based on a non-local means algorithm for image denoising. This algorithm may inherently denoise the prediction without explicit denoising of the reference pixels. The prediction technique has considerable performance increase. Also the complexity of the method is relatively low, which makes it easier to be used in technical applications. Particularly, no set of (e.g., linear) equations has to be solved in comparison to least-squares prediction methods in the prior art. The accuracy of the prediction method may be configured with the number of patches for forming the predictor. Furthermore, no side information (e.g., weights) needs to be transmitted, thus keeping the total data rate of the image stream low. Moreover, different enhancements may be implemented in order to improve the quality of the predictor or reduce the complexity as has been described in the foregoing.

The prediction method may be configured for lossless coding in conventional block-based image encoders and decoders, which provides that no transform quantization, loop-filtering, dequantization, and inverse transform have to be performed and the prediction may be carried out pixel-wise. This denotes that the prediction error does not depend on the pixel position. For example, the prediction error is not increasing with increasing distance to the neighboring blocks.

An example of the NLM prediction algorithm has been tested. A version of this algorithm has been implemented in a reference software based on the draft standard HEVC. The DC prediction type or the PLANAR prediction type according to the reference software was replaced by an NLM predictor. For coding tests, ten frames of different video sequences were coded. The coding tests have been performed using different sets of video sequences.

The simulation results for the NLM prediction are summarized in Table 1 below. In this table, the first column refers to different videos named as SVTshort, MedicoISI, ClassD and ClassF. The second column refers to a comparison of an integer version of the NLM prediction with the DC prediction mode. The third column refers to a comparison of an integer version of the NLM prediction with the PLANAR prediction mode. In the lines for each video, the reduction of the bitrate for the NLM prediction algorithm in comparison to the DC and PLANAR mode as well as the encoding and decoding time in percent for the NLM prediction algorithm in comparison to the DC and PLANAR mode are depicted. An encoding and decoding time of 100% refers to the encoding and decoding time of the DC and PLANAR mode, respectively.

TABLE 1

| | NLMint DC | NLMint PLANAR |
|---|---|---|
| SVTshort | | |
| Δ Bitrate in | — | — |
| % | 4.75 | 4.90 |
| MedicoISI | | |
| Δ Bitrate in | — | — |
| % | 3.21 | 3.85 |
| ClassD | | |
| Δ Bitrate in | — | — |
| % | 5.70 | 5.78 |
| ClassF | | |
| Δ Bitrate in | — | — |
| % | 7.55 | 7.72 |

As may be seen from the table, the bitrate is saved when using the NLM predictor. Moreover, also a considerable runtime decrease is achieved in the decoder and the encoder when using the NLM prediction mode. Hence, a considerably better coding performance may be achieved by the NLM prediction mode in comparison to prediction modes according to the prior art.

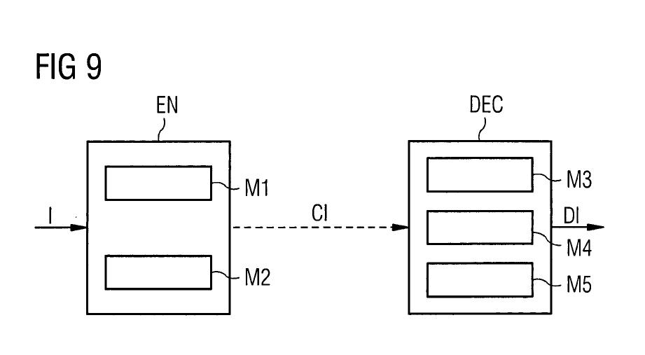

FIG. 9 depicts a schematic illustration of a codec including a coding apparatus and a decoding apparatus using the prediction mode. In the scenario of FIG. 9, a sequence of images is fed to an encoder EN. For performing the NLM prediction mode, the encoder includes a device M1 for determining similarity measures. Based on a region of pixels with reconstructed values in a single image and for a template of an image area, this device compares a first patch of pixels in this region that surrounds a first pixel to be predicted based on the template with several second patches, each second patch being assigned to a second pixel in the region and including pixels in the region that surrounds the second pixel based on the template. As a result, a similarity measure for each second pixel describing the similarity between reconstructed values of the pixels of the second patch assigned to the respective second pixel and the reconstructed values of the pixels of the first patch is determined.

The encoder further includes a device M2 for predicting values of first pixels. To do so, a predicted value of each first pixel is determined based on a weighted sum of values of the second pixels, where a weight of a value of a second pixel is monotonously decreasing in dependency on a decreasing similarity described by the similarity measure for the second pixel.

Based on this prediction, a prediction error is obtained, which is transmitted as the coded sequence of images CI to a decoder DEC. In the decoder DEC, the prediction method used in the encoder is analogously implemented. Particularly, the decoder includes a device M3 for determining similarity measures. For a region of pixels with decoded values in a single image that have been determined previously in the decoding processing and for a template of an image area, this device compares a first patch of pixels in the region that surrounds the first pixel to be predicted based on the template with several second patches, each second patch being assigned to a second pixel in the region and including pixels in the region that surrounds the second pixel based on the template. As a result, a similarity measure for each second pixel describing the similarity between decoded values of the pixels of the second patch assigned to the respective second pixel and the decoded values of the pixels of the first patch is determined.

Furthermore, the decoder DEC includes a device M4 for predicting values of first pixels. To do so, a predicted value of each first pixel is determined based on a weighted sum of values of the second pixels, where a weight of a value of a second pixel is monotonously decreasing in dependency on a decreasing similarity described by the similarity measure for the second pixel.

Moreover, the decoder DEC includes a device M5 for correcting the predicted value of the first pixel. To do so, the predicted value of the first pixel is corrected by the corresponding prediction error for the first pixel resulting in a decoded value of the first pixel. The prediction error is included in the received sequence of images CI. Eventually, a sequence of images DI is obtained by the decoder that corresponds to the original sequence of images I in case that a lossless coding and decoding has been used.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for coding a sequence of digital images, the method comprising:
predicting values of pixels in the digital images, using a number of prediction modes, based on reconstructed values of pixels in image areas previously processed;
processing a prediction error between the predicted values and original values of the pixels; and
generating a coded sequence of the digital images using the processed prediction error;
wherein a prediction mode of the number of prediction modes is a preset prediction mode which is an intra-prediction mode based on pixels of a single image, wherein the preset prediction mode:
i) for a region of pixels with reconstructed values in the single image and for a template of an image area, a first patch of pixels in the region surrounding a first pixel to be predicted based on the template is compared with several second patches, each second patch being assigned to a second pixel in the region and comprising pixels in the region surrounding the second pixel based on the template, thereby determining a similarity measure for each second pixel describing the similarity between reconstructed values of the pixels of the second patch assigned to the respective second pixel and the reconstructed values of the pixels of the first patch; and
ii) a predicted value of each first pixel is determined based on a weighted sum of values of the second pixels, where the value of each second pixel is weighted by a weighting factor that is monotonously decreasing in dependency on a decreasing similarity described by the similarity measure for the respective second pixel.

2. The method according to claim 1, wherein weighting factors are the similarity measures or approximated values of the similarity measures or the weighting factors are the similarity measures normalised over all similarity measures determined in act i) or approximated values of the similarity measures normalised over all similarity measures determined in act i).

3. The method according to claim 1, wherein the preset prediction mode is performed block-wise for first pixels in predetermined image blocks.

4. The method according to claim 1, wherein the similarity measure is based on a sum of absolute or squared differences between corresponding pixels in the first patch and the respective second patch.

5. The method according to claim 4, wherein the sum of absolute or squared differences is included in the similarity measure as at least a part of a negative exponent of a basis, where the basis has the value 2.

6. The method according to claim 1, wherein one or more of the similarity measure in act i) or the predicted value of each first pixel in act ii) is determined based on an integer arithmetic.

7. The method according to claim 1, wherein a look-up in a predefined table is used for determining the similarity measures in act i), the table providing values of the similarity measure for values of the sum of absolute or squared differences between corresponding pixels in the first patch and the respective second patch.

8. The method according to claim 1, wherein the preset prediction mode is used for lossless coding of the sequence of images, where the reconstructed values of pixels are the original values of pixels.

9. The method according to claim 1, wherein the preset prediction mode is used for lossy coding of the sequence of images.

10. The method according to claim 9, wherein the lossy coding includes a transform, a quantization or the transform and the quantization of the prediction errors, where an inverse transform, a dequantization, or the inverse transform and the dequantization of the prediction errors are performed for determining reconstructed values of pixels.

11. The method according to claim 1, wherein the processing of the prediction error comprises an entropy coding act.

12. The method according to claim 1, wherein, for each first pixel to be predicted, one or more of the following is determined:
(1) whether the preset prediction mode or another prediction mode is to be used for the first pixel; or
(2) which parameter or parameters of the first prediction mode are used.

13. The method according to claim 1, wherein, when all similarity measures determined in act i) are zero, another prediction mode is used for predicting the first pixel.

14. The method according to claim 1, wherein one or more parameters of the preset prediction mode are fixed, variable, or fixed and variable, where the one or more parameters comprise one or more of:
a form and a size of the template,
a form and size of the region,
one or more parameters referring to the determination of the similarity measures, or
the determination of predicted values of first pixels.

15. The method according to claim 1, wherein the preset prediction mode, parameters of the preset prediction mode, or the preset prediction mode and the parameters of the preset prediction mode are signaled in the coded sequence of images.

16. The method according to claim 1, wherein the preset prediction mode is used as a prediction mode in the standard HEVC/H.265.

17. A method for decoding a sequence of digital images coded by (1) predicting values of pixels in digital images, using a number of prediction modes, based on reconstructed values of pixels in image areas previously processed, (2) processing a prediction error between the predicted values and original values of the pixels, and (3) generating a coded sequence of the digital images using the processed prediction error, the method comprising:
reconstructing the prediction error from the coded sequence of images; and
decoding the values of the pixels in the coded sequence of images processed by a preset prediction mode during coding, wherein:
i) for a region of pixels with decoded values in a single image that have been determined previously in the decoding processing and for a template of an image area, a first patch of pixels in the region surrounding a first pixel to be predicted based on the template is compared with several second patches, each second patch being assigned to a second pixel in the region and comprising pixels in the region surrounding the second pixel based on the template, thereby determining a similarity measure for each second pixel describing the similarity between decoded values of the pixels of the second patch assigned to the respective second pixel and the decoded values of the pixels of the first patch;
ii) a predicted value of each first pixel is determined based on a weighted sum of values of the second pixels, where the value of each second pixel is weighted by a weighting factor that is monotonously decreasing in dependency on a decreasing similarity described by the similarity measure for the respective second pixel;
iii) the predicted value of each first pixel is corrected by the corresponding reconstructed prediction error for the first pixel resulting in a decoded value of the first pixel.

18. A method for coding and decoding a sequence of digital images,
predicting values of pixels in the digital images, using a number of prediction modes, based on reconstructed values of pixels in image areas previously processed;
processing a prediction error between the predicted values and original values of the pixels;
generating a coded sequence of the digital images using the processed prediction error, wherein a prediction mode of the number of prediction modes is a preset prediction mode, which is an intra-prediction mode based on pixels of a single image,
reconstructing the prediction error from the coded sequence of images; and
decoding the values of the pixels in the coded sequence of images processed by the preset prediction mode during coding.

19. An apparatus for coding a sequence of images, the apparatus comprising:
a predictor configured to perform a number of prediction modes for predicting values of pixels in the images based on reconstructed values of pixels in image areas processed previously, where the prediction error between predicted values and the original values of pixels is processed for generating the coded sequence of digital images;
wherein the predictor is configured to perform a preset prediction mode that is an intra-prediction mode based on pixels of a single image, wherein the predictor comprises an encoder configured to:
determine similarity measures, the determination of the similarity measures comprising performance of an act in which, for a region of pixels with reconstructed values in the single image and for a template of an image area, a first patch of pixels in the region surrounding a first pixel to be predicted based on the template is compared with several second patches, each second patch being assigned to a second pixel in the region and comprising pixels in the region surrounding the second pixel based on the template, thereby determining a similarity measure for each second pixel describing the similarity between reconstructed values of the pixels of the second patch assigned to the respective second pixel and the reconstructed values of the pixels of the first patch; and
predict values of first pixels, the prediction of the values of first pixels comprising performance of an act in which a predicted value of each first pixel is determined based on a weighted sum of values of the second pixels, where the value of each second pixel is weighted by a weighting factor that is monotonously decreasing in dependency on a decreasing similarity described by the similarity measure for the respective second pixel.

20. (canceled)

21. An apparatus for decoding a sequence of digital images, the apparatus comprising:
a decoder configured to reconstruct a prediction error from a coded sequence of images and to decode values of pixels in the coded sequence of images that are processed by a preset prediction mode during coding, wherein the decoder is configured to:
determine similarity measures, the determination of the similarity measures comprising performance of an act in which for a region of pixels with decoded values in the single image that have been determined previously in decoding processing and for a template of an image area, a first patch of pixels in the region surrounding a first pixel to be predicted based on the template is compared with several second patches, each second patch being assigned to a second pixel in the region and comprising pixels in the region surrounding the second pixel based on the template, thereby determining a similarity measure for each second pixel describing the similarity between decoded values of the pixels of the second patch assigned to the respective second pixel and the decoded values of the pixels of the first patch;
predict values of first pixels, the prediction of the values of first pixels comprising performance of an act in which a predicted value of each first pixel is determined based on a weighted sum of values of the second pixels, where the value of each second pixel is weighted by a weighting factor that is monotonously decreasing in dependency on a decreasing similarity described by the similarity measure for the respective second pixel;
correcting the predicted values of first pixels, the correction of the predicted values of first pixels comprising performance of an act in which the predicted value of each first pixel is corrected by the corresponding reconstructed prediction error for the first pixel resulting in a decoded value of the first pixel.

22. A codec for coding and decoding a sequence of digital images, comprising:
a coding apparatus comprising a predictor configured to perform a number of prediction modes for predicting values of pixels in the images based on reconstructed values of pixels in image areas previously processed, where the prediction error between predicted values and the original values of pixels is processed for generating the coded sequence of digital images, wherein the predictor is configured to perform a preset prediction mode that is an intra-prediction mode based on pixels of a single image; and
a decoding apparatus comprising a decoder configured to reconstruct the prediction error from the coded sequence of digital images and to decode values of pixels in the coded sequence of images that are processed by the preset prediction mode during the coding.
